(19) United States
(12) Patent Application Publication
(10) Pub. No.: US 2008/0284905 A1
(43) Pub. Date: Nov. 20, 2008

(54) Schedulable multiple-formal video converting apparatus

(75) Inventor: Yun-Hsiang Chuang, Taipei (TW)

Correspondence Address: Edwards Angell Palmer & Dodge LLP, P.O.Box 55874, Boston, MA, 02205, US

(73) Assignee: Inventec Multimedia & Telecom Corporation, Taipei (TW)

(21) Appl. No.: 12/075,955

(22) Filed: Mar. 14, 2008

(30) Foreign Application Priority Data
May 17, 2007 (TW) 096117524

(51) Int. Cl. H04N 7/01

(52) U.S. Cl. 348/441; 348/E07.003

(57) ABSTRACT

A programmable scheduling video converting apparatus applicable for converting the stream of video transmission signals in both analog and digital formats that are generated from various types of video data sources—such as cable TVs, digital TVs, digital video data of American and Japanese specification, satellite set-top boxes, CD/DVD disc players, digital cameras and surveillance cameras, or various kinds of digital video files stored in computers—to a storage file format specified by the user. The present invention is characterized in that it has a programmable scheduling converting function and, unlike prior art designs that use computer software programs, it employs a hardware-based converting chip to carry out format conversion, thereby improving the speed of format conversion over prior techniques.

### BACKGROUND OF THE INVENTION

1. Field of the Invention

The present invention relates in general to digital video technologies, and, more particularly, to a programmable scheduling video converting apparatus applicable for converting the stream of video transmission signals generated and transmitted from various types of video data sources—such as cable TVs, digital TVs, digital video data of American or Japanese specification, satellite set-top boxes, CD/DVD disc players, digital cameras and surveillance cameras, or various kinds of digital video data files stored in computers-into digital video files in a file format specified by the user.

2. Background of the Related Art

Conventional multimedia container formats for PC use include AVI, WMV, MOV and MPG Thanks to advances in computing technology, a variety of portable multimedia players, known by the acronym PMP, are available to suit consumers' interests. For example, the Apple iPod, Sony PSP (PlayStation Portable) and Nintendo NDS are among the more widely popularized and commercialized, wherein each of these PMPs plays a set of one or more video formats that may differ from that of other players.

In that there are many types of multimedia container formats available for digital video files, if, for example, a user wishes to view a digital video file in the AVI format on a Sony PSP device, it is first required to convert the original digital video AVI format file into a PSP format file for PC use, and then download the converted PSP format file to the Sony PSP device for viewing.

Currently, format conversion of digital video files is generally carried out by means of PC software programs. In practical application, however, the method of using PC software for format conversion of video data files has some disadvantages. The disadvantages include user-inconvenience, increased difficulty with settings, the need for higher-end computer equipment and slow conversion times. Moreover, the existing video converting software programs only enable digital video files to be converted into digital video files in a file format required by the user for a certain player but not video transmission signals that are not in a file format, such as different kinds of TV broadcasting network programs transmitted and received directly from cable TVs, wireless TVs and satellite broadcasting data. Therefore, if the user wishes to record any of these kinds of TV broadcasting data into one of the formats for digital video files, doing so requires installation of a corresponding hardware TV card or receiver in a PC to achieve the purpose of recording and converting broadcast TV programs into digital video file formats for viewing, thereby necessitating expenditure on hardware equipment. Moreover, there are also a series of complicated installation and operation processes and steps that are required for the PC software to readily perform the task of format conversion, further inconveniencing users in practical use.

### SUMMARY OF THE INVENTION

Accordingly, an objective of the present invention is to solve at least the problems and disadvantages of the related art.

Another objective of the present invention is to provide a programmable scheduling video converting apparatus that facilitates the process and improves the speed of video container format conversion.

Another objective of the present invention is to provide a programmable scheduling video converting apparatus that enables the user to easily record all kinds of TV broadcasting network programs into digital video files for viewing in a storage format specified by the user.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

To achieve the objectives of the invention, as embodied and broadly described herein, a programmable scheduling video converting apparatus is applicable for converting the stream of video transmission signals generated from various types of video data sources such as cable TVs, digital TVs, American-specification digital video data, Japanese-specification digital video data, satellite set-top boxes, CD/DVD disc players, digital cameras and surveillance cameras, or various kinds of digital video files stored in PCs, into digital video files in a format specified by the user.

Structurally, the programmable scheduling video converting apparatus according to the present invention comprises at least: (A) a main control module that allows users to set a group of operation control parameters for converting and scheduling file format conversion, wherein the group of parameters for converting and scheduling format conversion comprises: the operation time period, the type of video data sources, and the targeted format for file conversion; (B) a video receiving interface module that is externally coupled to a video data source and is controlled by the main control module for receiving the stream of video data signals transmitted from the video data source at a certain period of time that is set by the user; (C) a digital video data file reading module that reads digital video data files stored in computers; (D) a video container format converting module that is controlled by the main control module for converting the stream of video data signals received by the video receiving interface module or for converting video data files read by the file reading module into a storage file format specified and set by the user; and (E) a data communication interface module which outputs strings of digital video data that have been format-converted by the video data format converting module to a multimedia data processing platform such as a PC.

In summary, the programmable scheduling video converting apparatus of the present invention is characterized in that it has a programmable scheduling converting function and, unlike prior art designs that use computer software programs, it employs a hardware converting chip for video data formats to carry out file format conversion, thereby improving the speed of format conversion over prior techniques.

### BRIEF DESCRIPTION OF THE DRAWINGS

The invention will be described in detail with reference to the following drawings in which:

FIG. 1A is an application diagram showing an application mode of the programmable scheduling video converting apparatus in accordance with the present invention;

FIG. 1B is another application diagram showing a further application mode of the programmable scheduling video converting apparatus in accordance with the present invention;

FIG. 2 is a diagram showing the basic architecture of the programmable scheduling video converting apparatus according to the present invention, and

FIG. 3 is a table showing operational functions of the programmable scheduling video converting apparatus according to the present invention.

### DETAILED DESCRIPTION OF THE PREFERRED EMBODIMENT

Reference will now be made in detail to the preferred embodiment of the present invention, examples of which are illustrated in the accompanying drawings.

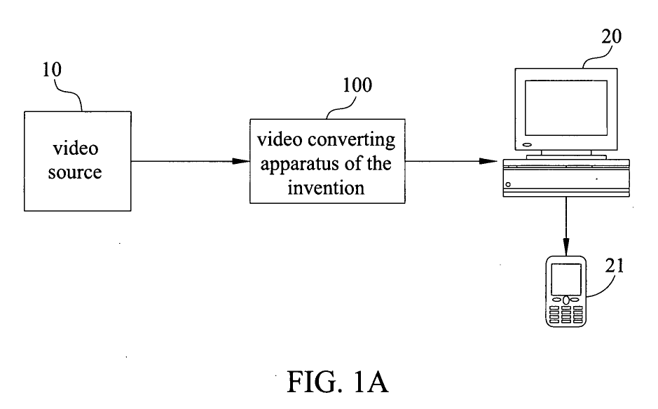

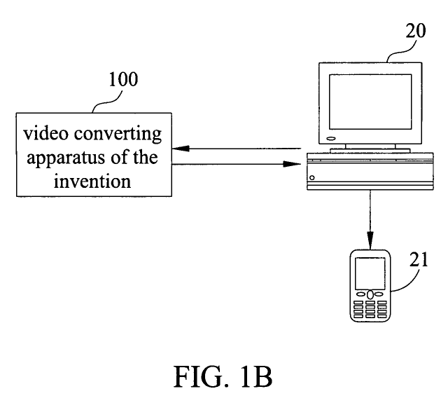

FIG. 1A shows an application mode of the programmable scheduling video converting apparatus in accordance with the present invention. As shown in this preferred embodiment, the video converting apparatus 100 of the invention is a standalone external device that is connected between a video source 10 and a multimedia data processing platform 20 such as a PC.

The types for the video data source include all kinds of broadcasting TV receivers, such as cable TVs, DVB-T (Digital Video Broadcasting-Terrestrial) digital TVs, NTSC (National Television Standards Committee) digital TVs of American-specification, ISDB-T (Integrated Services Digital Broadcasting-Terrestrial) digital TVs of Japanese-specification, satellite direct broadcasting TVs (satellite set-top boxes), and various kinds of video file storage devices or video players such as CD/DVD disc players, digital cameras and surveillance cameras.

The multimedia data processing platform 20 may be a PC (a desktop or notebook computer) or various types of portable video players 21 equipped with a video playing function, for example, Apple iPod, Sony PSP (PlayStation Portable) or Nintendo NDS. In actual application, the video converting apparatus 100 receives the stream of video signals generated and transmitted from the video source 10, and further converts the received video transmission signals into digital video files in a storage format specified by the user.

FIG. 1B depicts another application mode of the programmable scheduling video converting apparatus 100 in accordance with the present invention. In this embodiment, the multimedia data processing platform 20 (a desktop or notebook computer) serves as a video source capable of allowing the existing video files thereof to be format-converted by means of being externally connected to the video converting apparatus 100 of the present invention.

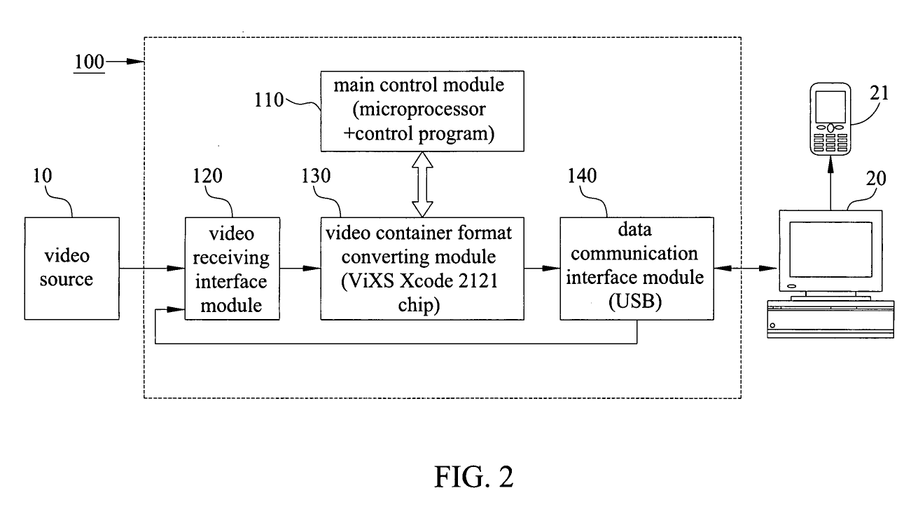

As depicted in FIG. 2, the basic structure of the programmable scheduling video converting apparatus 100 according to the present invention comprises at least: (A) a main control module 110; (B) a video receiving interface module 120; (C) a digital video data file reading module (not shown) that reads various types of digital video data files stored in computers; (D) a video container format converting module 130; and (E) a data communication interface 140. The individual attributes and functions of these constituent components are described in more detail below.

The main control module 110 may be a circuit unit combined of a microprocessor and a control program, the control program comprising a format converting scheduling control program which executes a converting scheduling control function on received signals from the video source 10, and the converting scheduling control function can be engaged, for example, when the video source 10 is a TV broadcasting system (including Cable TV, wireless TV or satellite direct broadcasting TV). The converting scheduling control function permits users to record TV programs to be shown at a certain period of time, and further convert the recorded TV programs into digital video files in a storage format specified by the user. In the case that the video source 10 is a CD/DVD player, the converting scheduling control function permits users to set certain sections of a program that users wish to copy. Or, if the video source 10 is a digital camera such as a surveillance camera, the scheduling control function allows the user to set the required time for recording and for file format conversion as desired. Basically, the conversion scheduling control function of the main control module 110 allows users to set a group of four parameters that includes: (1) START_TIME, comprising the time to commence recording/conversion; (2) END_TIME; (3) video sources, which comprise the selection items of CHANNEL, video files and real-time recording); and (4) the targeted FORMAT, which comprises the selection items of iPod, Sony PSP, NINTENDO NDS.

The video receiving interface module 120 is a multi-port type connector that can be externally connected to different kinds of video sources 10, for example, various types of broadcasting TV receivers (such as cable TVs, DVB-T digital TVs, NTSC digital TVs of American-specification, ISDB-T digital TVs of Japanese-specification, satellite direct broadcasting TVs [satellite set-top boxes], and all kinds of video file storage devices or video players such as CD/DVD disc players, digital cameras and surveillance cameras) to receive video signals generated therefrom. The video receiving interface module 120 receives video transmission signals in both analog and digital formats.

The video container format converting module 130 provides the function of video container format conversion using a digital logic circuit (meaning that the format conversion is not executed by a computer program on an attached computer), for converting the format of video signals originally received by the video receiving interface module 120 described above into digital video files in a targeted format set by the main control module 110. A main feature of the present invention is that, unlike prior art that uses computer software programs for format conversion, the video container format converting module 130 of the present invention uses a hardware-based video container format converting method using a chip to carry out format conversion, such as the Xcode 2121 chip developed by the company ViXS, such that the speed of format conversion is significantly improved over prior techniques.

The data communication interface 140 may be, for example, a Universal Serial Bus (USB) communications interface that externally connects the video converting apparatus 100 of the present invention to the multimedia data processing platform 20, such as a PC (a desktop or notebook computer) or various kinds portable video players 21 equipped with a video playing function, such as an iPod, Sony PSP (PlayStation Portable), Nintendo NDS and various other Portable Media Players (PMPs), and outputs the stream of digital video files that has been format-converted by the video container format converting module 130 described above to the external multimedia data processing platform 20. Further, if the portable video player device 21 is equipped with a USB communication interface, the data communication interface 140 may be directly connected to the portable video player device 21.

Moreover, working in the reverse direction, the data communication interface 140 can also be used to receive the stream of video signals transmitted from the external multimedia data processing platform 20, and transmit the received video signals to the video container format converting module 130 to be format-converted via the video receiving interface module 120.

The following four examples illustrate an overall operational mode in the application of the programmable scheduling video converting apparatus 100 of the present invention.

The first example involves the scenario where a user wishes to record a cable TV program to be shown at a certain period of time, the scheduling being accomplished by means of the time-setting recording mode. The user first needs to initiate the format-converting scheduling control function in the main control module 110 to set the necessary parameters: (1) START_TIME, (2) END_TIME, (3) CHANNEL (video sources), (4) and the target FORMAT. For example, if the user wishes to ultimately view a program on a Sony PSP, the targeted format is set to FORMAT=PSP. The main control module 110 has a timer which calculates the time until the START_TIME and periodically activates the video receiving interface module 12 to receive the stream of video signals received and transmitted from the video source 10 (a Cable TV receiver), and further filters out the video signals according to the required channel (i.e., tunes to the desired channel). Thereafter, the video container format-converting module 130 converts the format of the screened video signals according to the targeted FORMAT to a PSP file format specified by the user. Subsequently, the stream of PSP video files that has been format-converted is first transmitted to the multimedia data processing platform 20 (such a desktop or notebook computer) via the data communication interface module 140 (a USB interface), and then downloaded to the user's portable video player device 21 (such as the Sony PSP) for viewing on the device as desired.

Similarly, in a second example in which the user wishes to perform file format conversion of a certain section in a digital video file tvprogram.avi in the AVI format stored on a PC to a PSP file format, the user first needs to initiate the format-converting scheduling control function in the main control module 110 to set the necessary parameters: (1) START_TIME, (2) END_TIME, (3) video sources (the PC and the name of the video file to be converted, tvprogram.avi), (4) and the targeted FORMAT (PSP). For example, if the user sets the parameters with a START_TIME=10:30 and an END_TIME=32:30, the main control module 110 loads the video file selected by the user, activates the video container format converting module 130, reads the section of the video file starting from START_TIME=10:30 to END_TIME=32:30, converts the format from an AVI video file to a PSP video file (without altering the original) as selected by the user, and thereafter transmits the format-converted stream PSP video file to the multimedia data processing platform 20 (such as a desktop or notebook computer) via the data communication interface module 140 (such as a USB interface).

Similarly, in a third example in which the video source 10 is a surveillance camera and the user wishes to have video of a specific location recorded for 10 seconds at an interval of every 5 minutes, the user first needs to initiate the format-converting scheduling control function in the main control module 110 to set the necessary parameters: (1) START_TIME, which is set to start at an interval of every 5 minutes; (2) END_TIME which is set to discontinue after recording images after 10 seconds at a time; (3) the video source, which is set to be a surveillance camera; (4) and the targeted FORMAT, which is set to be the PSP. Upon initiation, the main control module 110 starts the video receiving interface module 120 at an interval of every 5 minutes to receive the stream of video signals output from the video source 10 (the surveillance camera); subsequently, the video container format converting module 130 is activated to convert the stream of video signals according to the targeted format set by the user to a digital video file in a PSP format as required, and thereafter transmits the format-converted PSP video file to the multimedia data processing platform 20 (such as a desktop or notebook computer) via the data communications interface module 140 (such as a USB interface).

Similarly, in a fourth example in which, as shown in FIG. 1B, this time, the multimedia data processing platform 20 (a desktop or notebook computer) functions as the video source and the format of the existing video files thereof is converted by means of externally connecting the programmable scheduling video converting apparatus 100 of the present invention. In this embodiment, the programmable scheduling video converting apparatus 100 of the present invention receives the stream of video signals transmitted from the multimedia data processing platform 20 (a PC) via the data communication interface module 140 (a USB interface) and the digital video data file reading module (not shown) and passes the corresponding data on to the video receiving interface module 120 (as shown by the lower arrow in FIG. 2), and further transmits via the video receiving interface module 120 the received video signals to the video container format converting module 130 for format conversion; and thereafter transmits the format-converted video data back to the multimedia data processing platform 20 via the data communication interface module 140 (a USB interface).

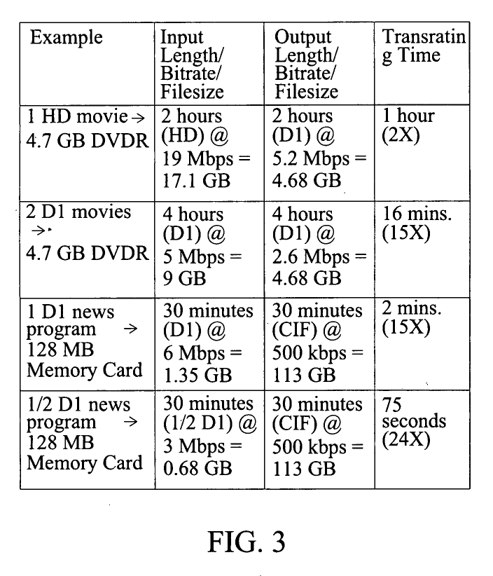

FIG. 3 is a table showing a comparison of format conversion of the programmable scheduling video converting apparatus 100 using Xcode 2121 of ViXS verses that of the known computer software programs. It can be seen clearly that the speed of format conversion carried out by the programmable scheduling video converting apparatus 100 of the present invention is noticeably faster than using computer software programs in prior techniques.

In conclusion, the programmable scheduling video converting apparatus of the present invention is characterized in that it has a programmable scheduling converting function and, unlike prior art designs that use computer software programs, the present invention employs hardware converting chips in video container format to carry out format conversion, thereby improving the speed of format conversion over prior art and having high industrial applicability.

While illustrative embodiments are provided in the above description, such are for illustration of the principles and functions of the present invention only and are not to be construed restrictively. Various modifications and variations of the present invention will be obvious to those skilled in the art but still fall within the spirit and scope of the invention as defined by the following claims.

What is claimed is:

1. A configurable scheduling multiple-format video converting apparatus applicable for connecting between a video source and a multimedia data processing platform to convert the encoding format of video signals generated and transmitted from the video source, comprising:
(A) a main control module that allows users to set a group of operational control parameters for converting and scheduling file format conversion, the group of parameters for converting and scheduling comprising: the operation period of time, the type of video data source, and the targeted format for carrying out file conversion;
(B) a video receiving interface module that is externally coupled to a video data source and is controlled by the main control module for receiving the stream of video data signals transmitted from the video data source at a certain period of time that is set by the user;
(C) a digital video data file reading module which reads various types of digital video data files stored in computers;
(D) a video container format converting module which is controlled by the main control module for converting the stream of video data signals received by the video receiving interface module or video data files read by the file reading module into a storage file format specified and set by the user; and
(E) a data communication interface module which outputs strings of digital video data that have been format-converted by the video data format converting module to a multimedia data processing platform.

2. The programmable scheduling video converting apparatus of claim 1, wherein the video data sources include broadcasting TV receivers and video players.

3. The configurable scheduling multiple-format video converting apparatus of claim 2, wherein the broadcasting TV receivers include cable TVs, DVB-T (Digital Video Broadcasting-Terrestrial) digital TVs, NTSC (National Television Standards Committee) digital. TVs of American-specification, ISDB-T (Integrated Services Digital Broadcasting-Terrestrial) digital TVs of Japanese-specification, and satellite direct broadcasting TVs (satellite set-top boxes).

4. The configurable scheduling multiple-format video converting apparatus of claim 2, wherein the video players include CD/DVD disc players, digital cameras and surveillance cameras.

5. The configurable scheduling multiple-format video converting apparatus of claim 1, wherein the operation time, START_TIME, is a parameter among the converting scheduling control parameters set by the main control module and comprises the time to commence conversion.

6. The configurable scheduling multiple-format video converting apparatus of claim 1, wherein the type of video source is a parameter among the converting scheduling control parameters set by the main control module and comprises the selection items of CHANNEL, video files and real-time recording.

7. The configurable scheduling multiple-format video converting apparatus of claim 1, wherein the video container format converting module is a hardware-based converting chip that is used to construct the video container format via logic circuits.

8. The configurable scheduling multiple-format video converting apparatus of claim 1, wherein the data communication interface is a Universal Serial Bus (USB) communication interface.

9. The configurable scheduling multiple-format video converting apparatus of claim 1, wherein the data communication interface is further connected to the video receiving interface module while connecting to an external multimedia data processing platform, thereby receiving the stream of video signals transmitted from the external multimedia data processing platform and transmitting the received video signals to the video container format converting module for format conversion via the video receiving interface module.
